(19) United States
(12) Patent Application Publication
(10) Pub. No.: US 2018/0104706 A1
(43) Pub. Date: Apr. 19, 2018

(54) Weed Removal Tool

(71) Applicant: Stewart Nagao, Racine, WI (US)

(72) Inventor: Stewart Nagao, Racine, WI (US)

(21) Appl. No.: 15/782,968

(22) Filed: Oct. 13, 2017

Related U.S. Application Data
(60) Provisional application No. 62/407,704, filed on Oct. 13, 2016.

(51) Int. Cl. B05B 1/14; A01B 1/16; B05B 15/06; B05B 12/00

(52) U.S. Cl. CPC B05B 1/14; B05B 12/002; B05B 15/065; A01B 1/16

(57) ABSTRACT

A weed removal tool. The weed removal tool includes an angular housing having a fluid channel disposed therein. A handle is disposed on a first end of the housing. The handle includes an opening on a lower end thereof configured to receive water from a hose. A nozzle is disposed on a second end of the housing, the nozzle comprising a hollow tubular member having a pointed end. A plurality of apertures are disposed on the pointed end. A trigger is disposed on the housing and is in operable communication with the nozzle. The nozzle is configured to release water through the apertures when the trigger is actuated to a depressed position. In use, the weed removal tool can be inserted into the ground to apply water to the root structure of the weed, which loosens the roots and saturates the soil, allowing the entire weed to be easily removed.

### CROSS REFERENCE TO RELATED APPLICATIONS

This application claims the benefit of U.S. Provisional Application No. 62/407,704 filed on Oct. 13, 2016. The above identified patent application is herein incorporated by reference in its entirety to provide continuity of disclosure.

### FIELD OF THE INVENTION

The present invention relates to gardening tools. More specifically, the present invention provides a weed removal tool that is insertable into the ground adjacent a weed in order to loosen its roots by saturating the surrounding soil with water for easy removal.

### BACKGROUND OF THE INVENTION

Many individuals enjoy cultivating a lawn or a garden. It is generally desirable to prevent weeds from growing in a lawn or garden. Weeds are typically unsightly and detract from the overall aesthetic qualities of a lawn or garden. Additionally, weeds can spread and multiply, causing damage to the surrounding plants.

One method of removing weeds is to spray the weed with a chemical weed killer. While this may effectively kill the weed, the chemical often takes a long time to actually take effect. Additionally, the weed killer chemicals tend to pollute the surrounding soil. The weed killer chemicals can even damage the plants the individual is trying to protect by getting rid of the weeds. Another method of removing a weed is to simply try to pull the weed out of the soil. However, weeds typically have long, expansive root structures. This makes it very difficult to pull the entire weed, including the root, out of the ground. Often, the exposed part of the weed breaks off from the root before the root is fully removed. When this happens, the weed quickly regrows from the roots, and the effort of removing the weed is wasted. In view of the above concerns, it is desirable to provide a weed removal tool that applies water pressure to saturate the soil surrounding the root system of the weed, which loosens the roots and softens the soil, allowing for the entire weed to be easily removed.

In light of the devices disclosed in the prior art, it is submitted that the present invention substantially diverges in design elements from the prior art and consequently it is clear that there is a need in the art for an improvement to existing animal deterring devices. In this regard the instant invention substantially fulfills these needs.

### SUMMARY OF THE INVENTION

In view of the foregoing disadvantages inherent in the known types of weed removal tools now present in the prior art, the present invention provides a weed removal tool wherein the same can be utilized for providing convenience for the user when removing weeds. The weed removal tool comprises an angular housing having a fluid channel disposed therein. A handle is disposed on a first end of the housing. The handle has an opening on a lower end thereof configured to receive water from a hose, and the opening is in fluid communication with the fluid channel. A nozzle is disposed on a second end of the housing. The nozzle is also in fluid communication with the fluid channel. The nozzle comprises a hollow tubular member having a pointed end, wherein the fluid channel extends into the hollow tubular member. A plurality of apertures are disposed on the pointed end. A trigger is disposed on the housing and is in operable communication with the nozzle. The nozzle is configured to release water from the water supply through the plurality apertures when the trigger is actuated to a depressed position. In use, the weed removal tool can be inserted into the ground to apply water to the root structure of the weed, which loosens the roots and soil, allowing the entire weed to be easily pulled from the soil.

One object of the present invention is to provide a weed removal tool that uses water to remove weeds rather than harsh chemicals.

Another object of the present invention is to provide a weed removal tool that receives water from a garden hose.

A further object of the present invention is to provide a weed removal tool that is lightweight, durable, easy to use, and inexpensive to manufacture.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the weed removal tool.

FIG. 2 shows a perspective view of the pointed end of the nozzle of the weed removal tool.

FIG. 3 shows a perspective view of the weed removal tool in use.

### DETAILED DESCRIPTION OF THE INVENTION

Reference is made herein to the attached drawings. Like reference numerals are used throughout the drawings to depict like or similar elements of the weed removal tool. For the purposes of presenting a brief and clear description of the present invention, the preferred embodiment will be discussed as used for removing weeds. The figures are intended for representative purposes only and should not be considered to be limiting in any respect.

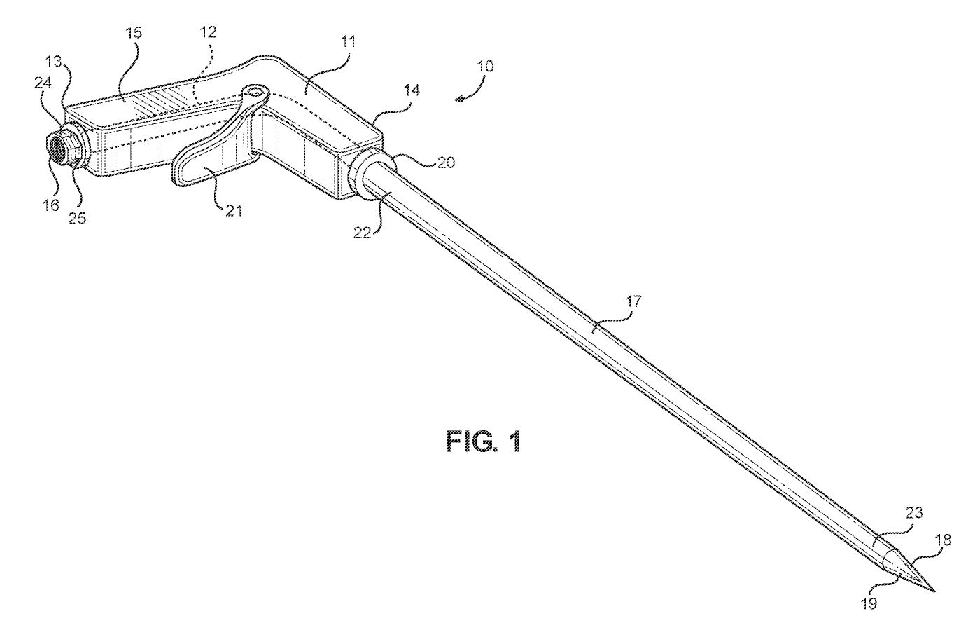

Referring now to FIG. 1, there is shown a perspective view of the weed removal tool. The weed removal tool 10 includes an angular housing 11 that includes a first end 13, an opposing second end 14, and an internal fluid channel 12 extending therebetween. In the illustrated embodiment, the first end 13 is substantially perpendicular to the second end 14. A handle 15 is disposed on the first end 13 of the housing 11. The handle 15 may include grooves or contours thereon to assist in gripping the housing 11. In some embodiments, the handle 15 may include a material having a coefficient of friction greater than one, such as rubber, in order to prevent the handle 15 from slipping from a user's grasp.

The handle 15 includes an opening 16 disposed on a distal end thereof. The opening 16 provides access to the fluid channel 12. In the shown embodiment, the opening 16 is disposed on a connector 24 that extends outwardly from the handle 15. The connector 24 is configured to receive a water supply hose, such as a garden hose, in order to transport water to the fluid channel 12. The connector 24 is shown having threading thereon for a removable threaded connection with a garden hose or other water supply hose. Alternatively, the connector 24 can be removably securable to the opening of a water supply hose via a snap fit or frictional engagement therewith. In the shown embodiment, a first flange 25 is disposed between the second end 13 of the housing 11 and the connector 24, such that the first flange 25 has a greater diameter than a diameter of the connector 24. The first flange 25 provides a contact point for the end of the water supply hose so that the water supply hose does not damage the housing 11 when connected thereto.

A nozzle 17 is disposed on the second end 14 of the housing 11. The nozzle 17 extends outwardly from the housing 11 such that the nozzle 17 is oriented parallel to the second end 14 of the housing 11. The nozzle 17 includes a hollow tubular member having a proximal end 22 and a distal end 23 having a pointed end 18 thereon. The pointed end 18 includes a plurality of apertures 19, each of which are in fluid communication with the fluid channel 12 of the housing 11 via the hollow nozzle 17. In the shown embodiment, a second flange 20 is disposed between a proximal end 22 of the nozzle 17 and the second end 14 of the housing 11. The second flange 20 includes a diameter that is greater than a diameter of the nozzle 17. In some embodiments, the nozzle 17 can be removably securable to the housing 11 via a frictional engagement or via a threaded connection with an internal threaded edge of the second flange 20, such that the nozzle 17 can be detached for easy and compact storage of the weed removal device 10.

A trigger 21 is disposed on the housing 11 between the first and second ends 13, 14 thereof. The trigger 21 is operably connected to a valve that is configured to selectively close off the fluid channel 12. When the trigger 21 is in a default undepressed position, the valve is closed and fluid cannot flow through the fluid channel 12. When the trigger 21 is actuated such that it is in a depressed position, the valve is opened and fluid is permitted to flow through the fluid channel 12. In the shown embodiment, the trigger 21 includes a planar front face and body that tapers inwardly from a proximal hinge to a distal end, which permits the trigger 21 to be easily depressed by a user.

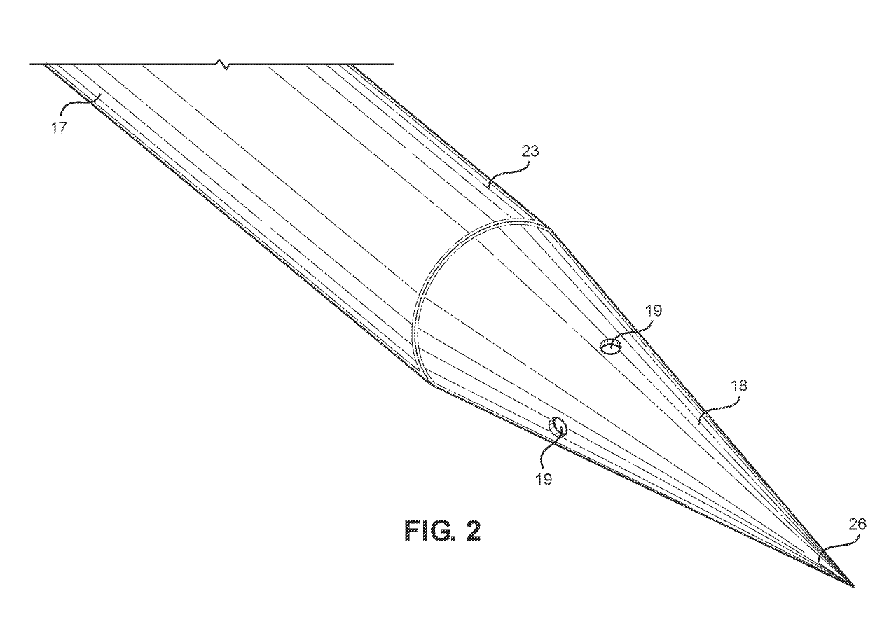

Referring now to FIG. 2, there is shown a perspective view of the pointed end of the nozzle of the weed removal tool. The nozzle 17 includes a uniform diameter between the proximal end and distal end 23 thereof. The pointed end 18 of the nozzle 17 is conical such that it tapers inwardly from the distal end 23 of the nozzle 17 and terminates in a ground-engaging point 26. The ground-engaging point allows the nozzle 17 to be easily inserted into soil adjacent a weed. In the shown embodiment, the plurality of apertures 19 are arranged in a circular linear arrangement about the circumference of the pointed end 18. In an alternate embodiment, the ground-engaging point 26 includes an additional aperture on the tip thereof to provide for additional fluid flow out of the nozzle 17.

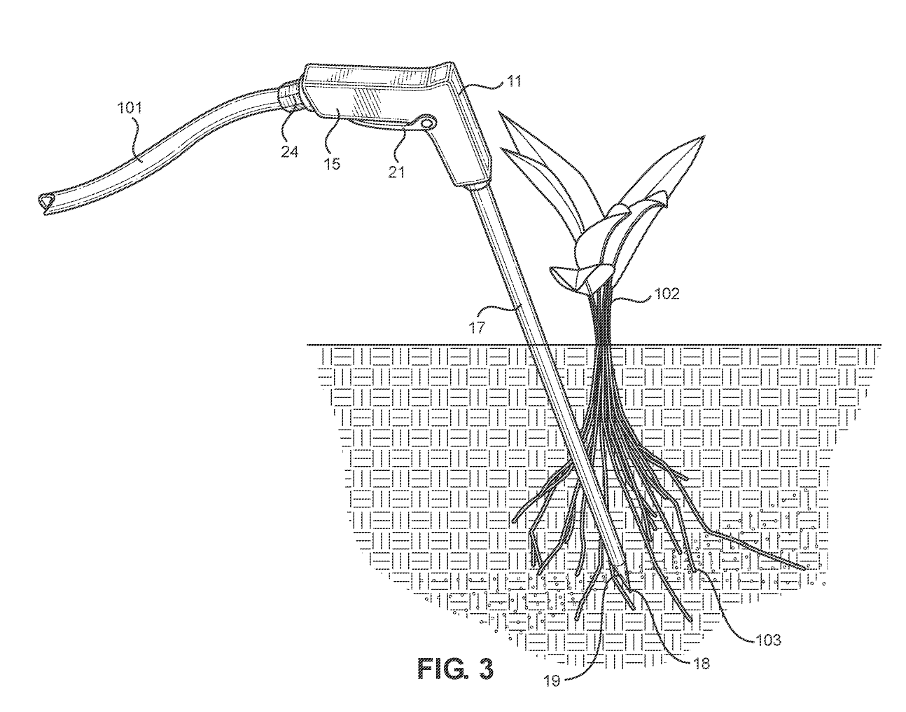

Referring now to FIG. 3, there is shown a perspective view of the weed removal tool in use. In order to easily and completely remove a weed, the housing 11 of the weed removal tool is connected to a water supply such as a garden hose 101 via the connector 24. The pointed end 18 of the nozzle 17 can then be inserted into the soil adjacent a weed 102, such that the pointed end 18 of the nozzle 17 is positioned in and around the root structure 103 of the weed 102. The user may grasp the handle 15 and actuate the trigger 21 to a depressed position, causing water to flow from the garden hose 101 through the housing 11 and the fluid nozzle 17 and exit the apertures 19 on the pointed end 18. The water is expelled from the apertures 19 amongst the root structure and causes both the roots and the soil around the roots to be loosened. The weed 102 can then be easily pulled from the soil, and the roots 103 will be removed since they have been loosened by the water. In this way, the weed 102 and its root structure 103 can be easily removed without the use of harmful chemicals.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A weed removal tool, comprising:
an angular housing having a fluid channel disposed therein;
a handle disposed on a first end of the housing, the handle having an opening on a lower end thereof configured to receive water from a hose, the opening in fluid communication with the fluid channel;
a nozzle disposed on a second end of the housing, the nozzle in fluid communication with the fluid channel, the nozzle comprising a hollow tubular member having a pointed end, wherein the fluid channel extends into the hollow tubular member;
a plurality of apertures disposed on the pointed end of the hollow tubular member;
a trigger disposed on the housing, the trigger in operable communication with the nozzle;
wherein the nozzle is configured to release water from the water supply through the plurality apertures when the trigger is actuated.

2) The weed removal tool of claim 1, wherein the nozzle is removably securable to the housing.

3) The weed removal tool of claim 1, wherein the handle opening includes a connector having a thread pattern thereon so as to removably couple to a garden hose having a corresponding thread pattern.

4) The weed removal tool of claim 1, wherein the plurality of apertures includes an endpoint aperture disposed on a tip of the pointed end of the nozzle.

5) The weed removal tool of claim 1, wherein the plurality of apertures are disposed on the nozzle in a linear arrangement such that the plurality of apertures encircle a circumference of the pointed end of the nozzle.

6) The weed removal tool of claim 1, wherein the nozzle is removably secured to the angular housing via a friction fit therewith.

7) The weed removal tool of claim 1, wherein the nozzle is removably secured to the angular housing via a threaded connection therewith.

8) The weed removal tool of claim 3, further comprising a first flange disposed between the connector and the lower end of the handle, wherein the first flange includes a diameter greater than a diameter of the connector.

9) The weed removal tool of claim 1, further comprising a second flange disposed between a proximal end of the nozzle and the second end of the housing, wherein the second flange includes a diameter greater than a diameter of the nozzle.

10) The weed removal tool of claim 1, wherein the trigger is configured to move between a undepressed position and a depressed position, wherein fluid is able to flow through the fluid channel only when the trigger is in the depressed position.
